(19) United States
(12) Patent Application Publication
(10) Pub. No.: US 2013/0091250 A1
(43) Pub. Date: Apr. 11, 2013

(54) INTERMEDIATE NODE APPARATUS FOR CONFIGURING SENSOR NETWORK AND SENSOR DATA PROCESSING METHOD USING INTERMEDIATE NODE APPARATUS

(71) Applicants: Seok Kap KO, Gwangju (KR); Seung Hun Oh, Gwangju (KR); Il Kyun Park, Daejeon (KR); Byung Tak Lee, Daejeon (KR); Young Sun Kim, Daejeon (KR)

(72) Inventors: Seok Kap KO, Gwangju (KR); Seung Hun Oh, Gwangju (KR); Il Kyun Park, Daejeon (KR); Byung Tak Lee, Daejeon (KR); Young Sun Kim, Daejeon (KR)

(73) Assignee: Electronics and Telecommunications Research Institute, Daejeon (KR)

(21) Appl. No.: 13/615,230

(22) Filed: Sep. 13, 2012

(30) Foreign Application Priority Data
Oct. 6, 2011 (KR) 10-2011-0101742

(51) Int. Cl. G06F 15/16

(52) U.S. Cl. 709/219

(57) ABSTRACT

Disclosed is an intermediate node apparatus for configuring a sensor network and a sensor data processing method using the intermediate node apparatus. The intermediate node apparatus may deliver sensor data measured by a sensor node apparatus to a neighboring node apparatus and may store the sensor data in a database.

### CROSS-REFERENCE TO RELATED APPLICATION

This application claims the priority benefit of Korean Patent Application No. 10-2011-0101742, filed on Oct. 6, 2011, in the Korean Intellectual Property Office, the disclosure of which is incorporated herein by reference.

### BACKGROUND

1. Field of the Invention

Exemplary embodiments of the present invention relate to an intermediate node apparatus for configuring a sensor network and a sensor data processing method using the intermediate node apparatus, and more particularly, to an apparatus and method for providing sensor data measured by a sensor node apparatus.

2. Description of the Related Art

Since a user requires information about a current location, there is a need to collect sensor data from a sensor close to the location of the user.

A method for collecting sensor data according to a related art is disclosed in Korean Patent Publication No. 2011-0070049 directed to a data collecting apparatus in a wireless sensor network, including a plurality of sensor nodes forming one cluster to propagate a state report message to at least one adjacent sensor node present in the cluster, and a cluster head sensor node to verify whether overlapped state report messages are present using a time stamp of state report messages delivered from at least one of the sensor nodes time synchronized, in advance and to deliver a single state report message formed from the overlapped state report messages to a sync node.

However, according to the conventional sensor network, even though a sensor located around a user is present, the user needs to access a server, in which sensor data of the user is stored, to receive the sensor data. As a result, an unnecessary amount of traffic and a data processing delay may occur.

In particular, when the sensor network is an intermittently connected network, sensor data may not be immediately collected in the server so that the user cannot receive up-to-date sensor data.

In the conventional sensor network, a gateway or a router serves a function of delivering data, and the delivered data is discarded directly. Recently, network service concept, for example, a web cache, a content delivery network (CDN), a content centric network (CCN), and the like, has appeared. The exemplary network services may store data within a network using a routing function of simply delivering a packet. To use the service network, modification is needed to collect and distribute sensor data.

Also, with the improvement in a processing capacity of a user terminal, the server does not have to treat or process sensor data. That is, when an overload or a malfunction is applied to the server, the network service may freeze. Accordingly, there is a desire to utilize the user terminal.

### SUMMARY

An aspect of the present invention provides an intermediate node apparatus that may store sensor data measured by a sensor node apparatus to enable collection of the sensor data without accessing a server.

Another aspect of the present invention also provides an intermediate node apparatus that may receive sensor data from a neighboring node apparatus or a sensor node apparatus, may store the sensor data, and may provide the sensor data to a user terminal.

Another aspect of the present invention also provides a user terminal that may connect to a neighboring intermediate node apparatus to collect sensor data without accessing a server, and may combine the collected sensor data and map data.

Another aspect of the present invention also provides an intermediate node apparatus that may correspond to a sensor gateway to collect sensor data through a mobile object after joining another intermediate node apparatus.

According to an aspect of the present invention, there is provided an intermediate node apparatus for configuring a sensor network including a data storing unit to receive sensor data from a first sensor node apparatus or a first neighboring node apparatus and to store the sensor data in a database, and a data delivery unit to deliver the sensor data stored in the database to a second neighboring node apparatus.

The intermediate node apparatus may further include a data searching unit to search the database for sensor data in response to a sensor data request message received from a user terminal, and a data providing unit to provide the found sensor data to the user terminal.

According to another aspect of the present invention, there is provided an intermediate node apparatus for configuring a sensor network including an apparatus joining unit to allow the intermediate node apparatus to join a neighboring node apparatus connected with at least one sensor, and a data storing unit to collect sensor data stored in the neighboring node apparatus through a mobile object and to store the collected sensor data in a database.

The intermediate node apparatus may further include a data searching unit to search the database for sensor data in response to a sensor data request message received from a user terminal connected with the intermediate node apparatus, and a data providing unit to provide the found sensor data to the user terminal.

According to still another aspect of the present invention, there is provided a user terminal connected with an intermediate node apparatus for configuring a sensor network, including a message transmitting unit to transmit a sensor data request message to the intermediate node apparatus, a data receiving unit to receive the sensor data in response to the request message being received, and a data combining unit to combine the received sensor data and additional data.

According to yet another aspect of the present invention, there is provided a sensor data processing method performed in an intermediate node apparatus for configuring a sensor network, including receiving sensor data from a first sensor node apparatus or a first neighboring node apparatus and storing the sensor data in a database, and delivering the sensor data stored in the database to a second neighboring node apparatus.

According to further another aspect of the present invention, there is provided a sensor data processing method performed in an intermediate node apparatus for configuring a sensor network, including joining a neighboring node apparatus connected with at least one sensor, collecting sensor data stored in the neighboring node apparatus through a mobile object, and storing the collected sensor data in a database.

According to still another aspect of the present invention, there is provided a sensor data processing method performed in a user terminal connected with an intermediate node apparatus for configuring a sensor network, including transmitting a sensor data request message to the intermediate node apparatus, receiving sensor data in response to the request message, and combining the received sensor data and additional data.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an example of providing sensor data to a user terminal according to an embodiment of the present invention;

FIG. 2 is a diagram illustrating components of a sensor network according to an embodiment of the present invention;

FIG. 3 is a diagram illustrating operation of an intermediate node apparatus according to an embodiment of the present invention;

FIG. 4 is a diagram illustrating a detailed configuration of an intermediate node apparatus according to an embodiment of the present invention;

FIG. 5 is a diagram illustrating a detailed configuration of a user terminal according to an embodiment of the present invention;

FIG. 6 is a diagram illustrating an example of providing sensor data to a user terminal in a delay tolerant network (DTN) according to an embodiment of the present invention;

FIG. 7 is a diagram illustrating a detailed configuration of an intermediate node apparatus according to another embodiment of the present invention;

FIG. 8 is a flowchart illustrating a sensor data storing process of an intermediate node apparatus according to an embodiment of the present invention;

FIG. 9 is a flowchart illustrating a sensor data searching process of an intermediate node apparatus according to an embodiment of the present invention;

FIG. 10 is a flowchart illustrating a sensor data storing process of an intermediate node apparatus in a DTN according to an embodiment of the present invention; and

FIG. 11 is a flowchart illustrating operation of a user terminal according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

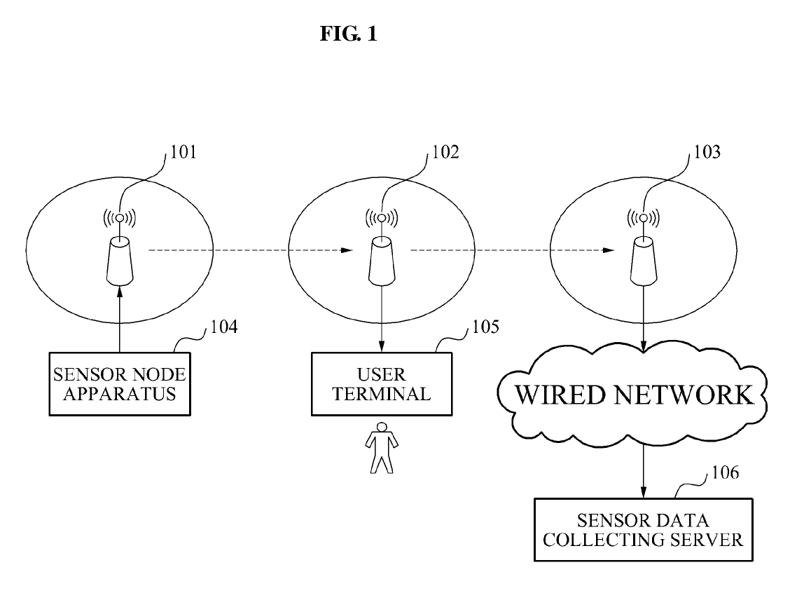

FIG. 1 is a diagram illustrating an example of providing sensor data to a user terminal according to an embodiment of the present invention.

Referring to FIG. 1, a sensor node apparatus 104 may measure sensor data. The measured sensor data may be delivered to a sensor data collecting server 106 through intermediate node apparatuses 101, 102, and 103 that may be included in a sensor network. For example, the sensor network may include a wireless mesh network. Also, the intermediate node apparatuses 101, 102, and 103 may correspond to access points (APs).

The intermediate node apparatuses 101, 102, and 103 may have a Zigbee interface and a wireless fidelity (WiFi) interface. The sensor data measured by the sensor node apparatus 104 may be delivered to the intermediate node apparatus 101 using a Zigbee communication protocol.

The intermediate node apparatuses 101, 102, and 103 according to an embodiment of the present invention may deliver the sensor data measured by the sensor node apparatus 104 to the sensor data collecting server 106. That is, the intermediate node apparatuses 101, 102, and 103 may perform a routing function. Also, the intermediate node apparatuses 101, 102, and 103 may store the sensor data measured by the sensor node apparatus 104 in a database.

Here, a user may access the sensor data collecting server 106 to receive the sensor data measured by the sensor node apparatus 104 through a user terminal 105. However, since the user terminal 105 needs to access the sensor data collecting server 106 through the intermediate node apparatuses 102 and 103 and then receive the sensor data through the intermediate node apparatuses 102 and 103, an unnecessary amount of traffic and a data processing delay may occur.

When the intermediate node apparatus 102 regionally associated with the user terminal 105 is present, the user terminal 105 may access the intermediate node apparatus 102 directly, using a communication protocol, for example, WiFi or Zigbee, to receive the sensor data. Accordingly, an amount of unnecessary traffic and a data processing delay may be prevented. In this instance, the user terminal 105 may access the regionally associated intermediate node apparatus 102 without a positioning apparatus, for example, a global positioning system (GPS).

Although communication schemes of the present invention are described with reference to WiFi and Zigbee, the communication schemes are not limited thereto and may include any wired and wireless communication scheme allowing data transmission.

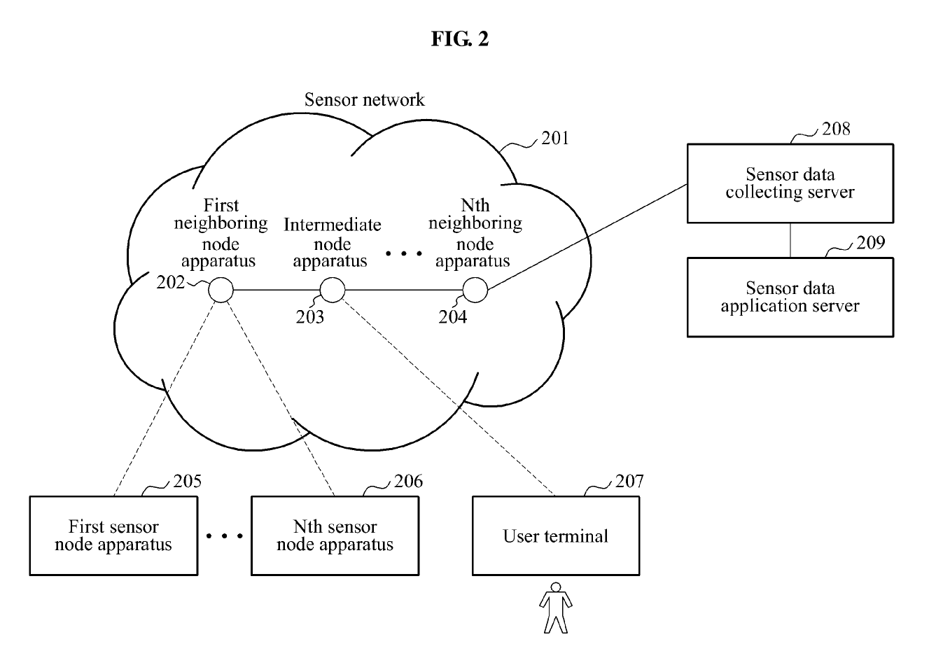

FIG. 2 is a diagram illustrating components of a sensor network 201 according to an embodiment of the present invention.

Referring to FIG. 2, the sensor network 201 may include neighboring node apparatuses 202 and 204 and an intermediate node apparatus 203. The neighboring node apparatuses 202 and 204 and the intermediate node apparatus 203 may perform the same function, and are described herein as distinctive components for convenience of description. The sensor network 201 may include at least two node apparatuses. In this instance, the intermediate node apparatus 203 may include a sensor gateway, an AP, and a mobile terminal. According to the exemplary embodiments, when the first neighboring node apparatus 202 is absent in the sensor network 201, the intermediate node apparatus 203 may be directly connected to at least one of a first sensor node apparatus 205 to an Nth sensor node apparatus 206.

The sensor data measured by the first sensor node apparatus 205 to the Nth sensor node apparatus 206 may be delivered to a sensor data collecting server 208 through the first neighboring node apparatus 202, the intermediate node apparatus 203, and the Nth neighboring node apparatus 204. A sensor data application server 209 may combine the sensor data delivered to the sensor data collecting server 208 and a map by reflecting locations of the first sensor node apparatus 205 to the Nth sensor node apparatus 206 on the map.

According to an embodiment of the present invention, the sensor data measured by the first sensor node apparatus 205 to the Nth sensor node apparatus 206 may be stored in each of the first neighboring node apparatus 202, the intermediate node apparatus 203, and the Nth neighboring node apparatus 204. In particular, when the sensor network 201 is a network having an intermittent connectivity, for example, a delay tolerant network (DTN), an immediate connectivity may not be guaranteed. Accordingly, the first neighboring node apparatus 202, the intermediate node apparatus 203, and the Nth neighboring node apparatus 204 may store the received sensor data for a predetermined period of time, and when connectivity is secured, may deliver the sensor data to a next node apparatus.

Also, the user terminal 207 may access the intermediate node apparatus 203 to receive sensor data without accessing the sensor data collecting server 208.

For example, the user terminal 207 may transmit a sensor data request message to the intermediate node apparatus 203. The intermediate node apparatus 203 may search a database for sensor data corresponding to the request message and may provide the found sensor data to the user terminal 207. The intermediate node apparatus 203 may store the sensor data in the database for a predetermined period of time, and may update the sensor data.

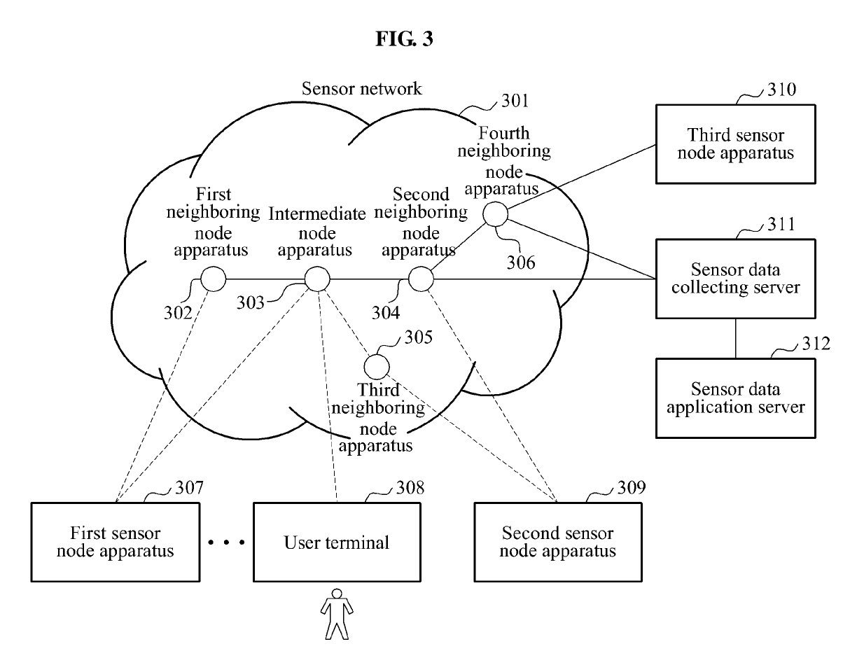

FIG. 3 is a diagram illustrating operation of an intermediate node apparatus according to an embodiment of the present invention.

According to an embodiment of the present invention, a first neighboring node apparatus 303, a second neighboring node apparatus 304, a third neighboring node apparatus 305, and a fourth neighboring node apparatus 306 may be included in a sensor network 301, and may perform the same operation with an intermediate node apparatus 302. Hereinafter, a description of the operation of a node apparatus provided with reference to FIG. 3 is based on the intermediate node apparatus 302.

The intermediate node apparatus 302 may classify a message received from the outside. For example, the intermediate node apparatus 302 may receive a message transmitted by the first neighboring node apparatus 303, a message transmitted by a first sensor node apparatus 307, and a message transmitted by a user terminal 308.

The message transmitted by the first neighboring node apparatus 303 and the message transmitted by the first sensor node apparatus 307 may include sensor data. In this instance, the intermediate node apparatus 302 may store the sensor data included in the message in a database. Here, the database may correspond to a data storage, for example, a memory or a file storage included in the intermediate node apparatus 302. That is, the intermediate node apparatus 302 may analyze the message, extract a measured time and a measured location of the sensor data, and store the extracted data in the database.

Also, the message transmitted by the user terminal 308 may correspond to a sensor data request message. For example, the intermediate node apparatus 302 may search the database for sensor data corresponding to the sensor data request message, and may provide the found sensor data to the user terminal 308.

When the sensor data corresponding to the sensor data request message is absent in the database, the intermediate node apparatus 302 may send the sensor data request message to a sensor data collecting server 311. The intermediate node apparatus 302 may receive the sensor data corresponding to the sensor data request message from the sensor data collecting server 311, and may provide the sensor data to the user terminal 308.

In this instance, the intermediate node apparatus 302 may modify a type of the request message. For example, when the intermediate node apparatus 302 is present at a boundary between a general Internet connection and a DTN complying with a bundle protocol, for example, IETF RFC 5050 on Bundle Protocol Specification, the intermediate node apparatus 302 may convert a request message of a bundle type into a Hypertext Transfer Protocol (HTTP) type. Conversely, the intermediate node apparatus 302 may convert a request message of an HTTP type into a bundle type.

Also, when location information of the user terminal 308 is absent in the sensor data request message, the intermediate node apparatus 302 may include a location of the intermediate node apparatus 302 in the request message. That is, when the user terminal 308 is not provided with a positioning apparatus, for example, a GPS, the intermediate node apparatus 302 regionally close to the user terminal 308 may include location information of the intermediate node apparatus 302 in the request message, instead of location information of the user terminal 308.

As an example, the intermediate node apparatus 302 may search for a second sensor node apparatus 309 regionally associated with the intermediate node apparatus 302 and may to join the second sensor node apparatus 309. In this instance, the intermediate node apparatus 302 may join the second sensor node apparatus 309 through a third neighboring node apparatus 305 authorized to enable joining in the second sensor node apparatus 309.

As another example, the intermediate node apparatus 302 may join a third sensor node apparatus 310 associated with sensor data requested to be collected at least a predetermined number of times set by the user terminal 308. In this instance, each time the third sensor node apparatus associated 310 measures sensor data, the third sensor node apparatus 310 may provide the sensor data to the intermediate node apparatus 302.

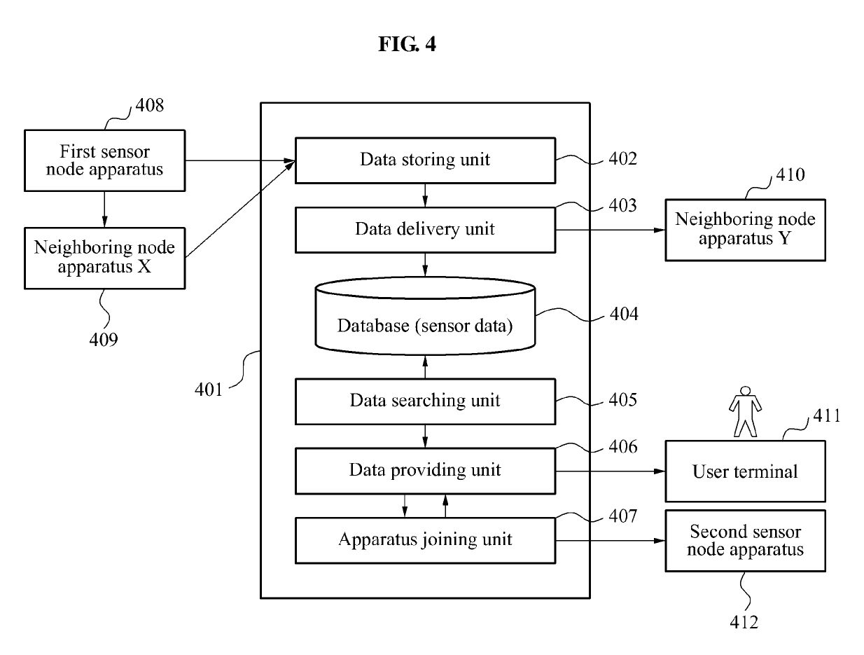

FIG. 4 is a diagram illustrating a detailed configuration of an intermediate node apparatus 401 according to an embodiment of the present invention.

Referring to FIG. 4, the intermediate node apparatus 401 may include a data storing unit 402 and a data delivery unit 403. Also, the intermediate node apparatus 401 may further include a data searching unit 405 and a data providing unit 406. Also, the intermediate node apparatus 401 may further include an apparatus joining unit 407.

The intermediate node apparatus 401 may analyze a message received from the outside. In this instance, when the message corresponds to a message received from a sensor node apparatus or a neighboring node apparatus, the intermediate node apparatus 401 may store sensor data included in the message. Also, when the message corresponds to a message received from a user terminal, the intermediate node apparatus 401 may provide sensor data corresponding to the message to the user terminal.

That is, the data storing unit 402 may receive sensor data measured by a first sensor node apparatus 408 or sensor data stored in a neighboring node apparatus X 409, and may store the sensor data in a database 404. In this instance, the neighboring node apparatus X 409 may receive and store sensor data measured by the first sensor node apparatus 408.

The data delivery unit 403 may deliver the sensor data received from the first sensor node apparatus 408 or the neighboring node apparatus X 409 to a neighboring node apparatus Y 410. That is, the intermediate node apparatus 401 may perform a data routing function.

Also, when a sensor data request message is received from a user terminal 411, the data searching unit 405 may search for sensor data from a database 404. The data providing unit 406, in response to the request message of the user terminal 411, may provide the sensor data found in the database 404 to the user terminal 411.

When the sensor data corresponding to the request message of the user terminal 411 is absent in the database 404, the data providing unit 406 may deliver the request message to a sensor data collecting server through the neighboring node apparatus Y 410. Alternatively, the data providing unit 406 may generate an error response message and may provide the error response message to the user terminal 411.

The apparatus joining unit 407 may search for a second sensor node apparatus 412 regionally associated with the intermediate node apparatus 401 and may allow the intermediate node apparatus 401 to join the second sensor node apparatus 412. The apparatus joining unit 407 may verify identification (ID) information or an address of the second sensor node apparatus 412. In this instance, the apparatus joining unit 407 may allow the intermediate node apparatus 401 to join the second sensor node apparatus 412 by delivering a join message to the second sensor node apparatus 412 through a neighboring node apparatus authorized to enable joining in the second sensor node apparatus 412.

Also, the apparatus joining unit 407 may allow the intermediate node apparatus 401 to join the second sensor node apparatus 412 associated with sensor data requested to be collected at least a predetermined number of times set by the user terminal. In this instance, each time the second sensor node apparatus 412 measures sensor data, the second sensor node apparatus 412 may provide the sensor data to the data storing unit 403. The sensor data may be delivered through an overlay multicast technology.

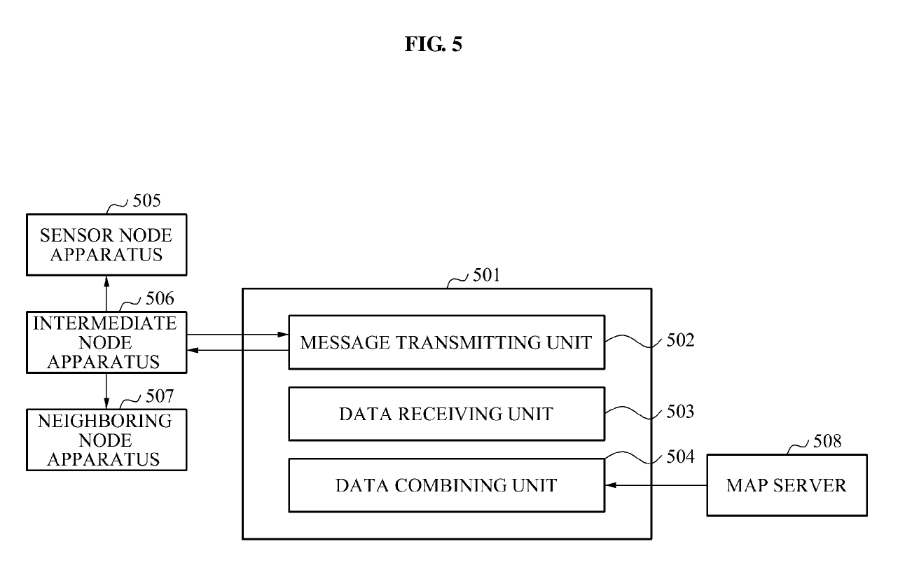

FIG. 5 is a diagram illustrating a detailed configuration of a user terminal 501 according to an embodiment of the present invention.

Referring to FIG. 5, the user terminal 501 may include a message transmitting unit 502, a data receiving unit 503, and a data combining unit 504.

The message transmitting unit 502 may transmit a sensor data request message to an intermediate node apparatus 506. That is, the user terminal 501 may initially access the intermediate node apparatus 506 to receive sensor data.

The data receiving unit 503 may receive sensor data corresponding to the request message from the intermediate node apparatus 506. In this instance, the intermediate node apparatus 506 may analyze the request message transmitted by the message transmitting unit 502, may search a database for sensor data corresponding to the request message, and may transmit the sensor data to the data receiving unit 503.

In this instance, sensor data stored in the database may correspond to sensor data that the intermediate node apparatus 506 may receive from a sensor node apparatus 505. Alternatively, the intermediate node apparatus 506 may receive sensor data measured by the sensor node apparatus 505 through a neighboring node apparatus 507.

The data combining unit 504 may combine the sensor data and additional data. For example, the data combining unit 504 may combine the sensor data and map data and may display the combined data. In this instance, the map data may be received from any one of the intermediate node apparatus 506 and a map server 508. The data combining unit 504 may convert a format of the sensor data to combine the sensor data and map data.

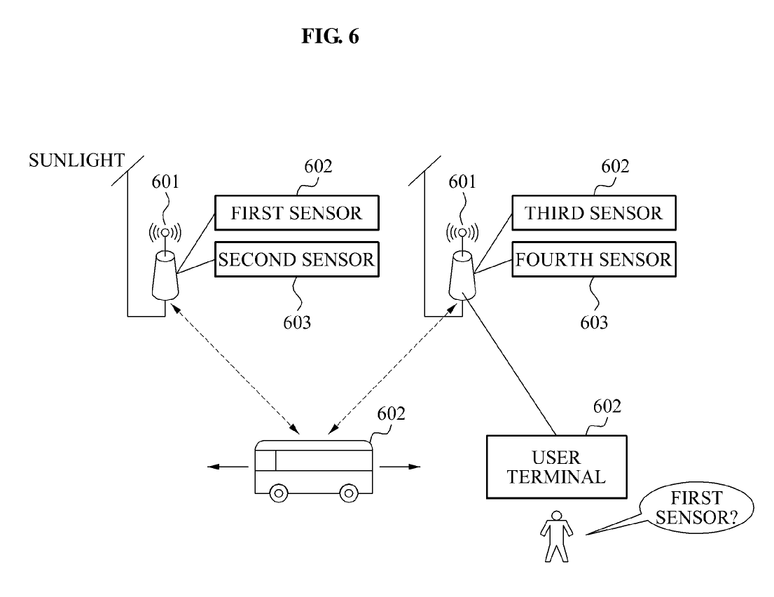

FIG. 6 is a diagram illustrating an example of providing sensor data to a user terminal in a DTN according to an embodiment of the present invention.

Referring to FIG. 6, a first sensor 602 and a second sensor 603 may be connected with an intermediate node apparatus 601, and a third sensor 605 and a fourth sensor 606 may be connected with an intermediate node apparatus 604. That is, the intermediate node apparatuses 601 and 604 may act as a sensor gateway.

When sensors are installed over a broad range of regions, it is difficult to supply power and build a wired and wireless communication network. In this instance, the sensors 602, 603, 605, and 606 may be individually powered through solar power generation or wind power generation.

In FIG. 6, assume that the intermediate node apparatus 601 and the intermediate node apparatus 604 are included in a DTN having an intermittent connectivity. When a user terminal 608 connected with the intermediate node apparatus 604 may request sensor data measured by the third sensor 605 and the fourth sensor 606 connected with the intermediate node apparatus 604, directly.

However, when the user terminal 608 requests sensor data associated with the first sensor 602, the intermediate node apparatus 604 may collect sensor data associated with the first sensor 602 after joining the intermediate node apparatus 601 neighboring the intermediate node apparatus 604. For example, the intermediate node apparatuses 601 and 604 may not directly exchange data and may collect data through a mobile object 607, for example, a car and may store the data. Accordingly, the intermediate node apparatuses 601 and 604 in the DTN may exchange sensor data through the mobile object 607.

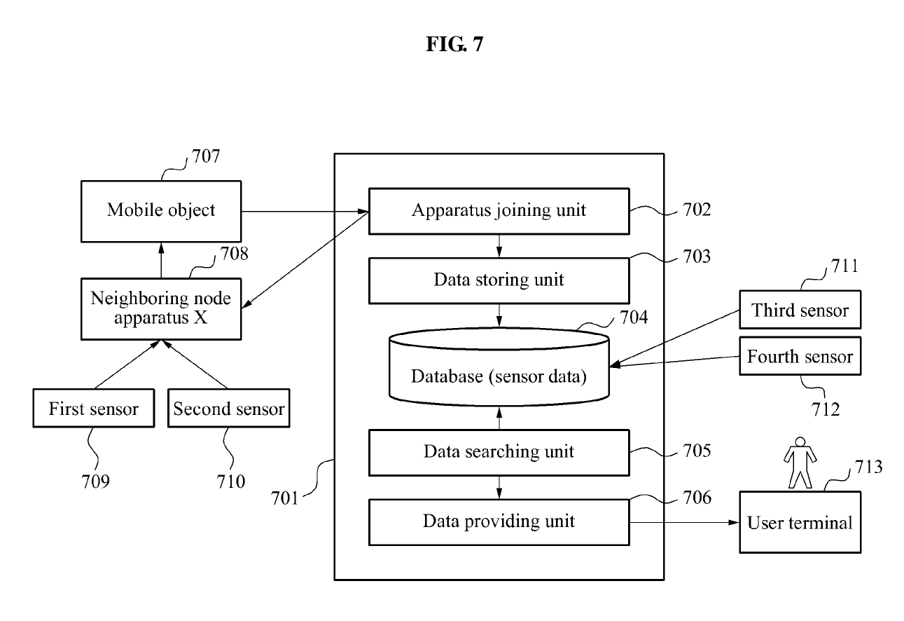

FIG. 7 is a diagram illustrating a detailed configuration of an intermediate node apparatus 701 according to another embodiment of the present invention.

Referring to FIG. 7, the intermediate node apparatus 701 may include an apparatus joining unit 702 and a data storing unit 703. Accordingly to the exemplary embodiments, the intermediate node apparatus 701 may further include a data searching unit 705 and a data providing unit 706.

The apparatus joining unit 702 may allow the intermediate node apparatus 701 to join a neighboring node apparatus X 708 connected with at least one sensor 709 and 710. In this instance, assume that the intermediate node apparatus 701 is connected with a third sensor 711 and a fourth sensor 712.

The data storing unit 703 may collect, through a mobile object 707, sensor data of the first sensor 709 and the second sensor 710 stored in the neighboring node apparatus X 708. The data storing unit 703 may store the collected sensor data in a database 704. Similarly, the data storing unit 703 may also store sensor data of the third sensor 711 and the fourth sensor 712 connected with the intermediate node apparatus 701.

The data searching unit 705 may search the database 704 for sensor data in response to a sensor data request message received from a user terminal 713 connected with the intermediate node apparatus 701. In this instance, the user terminal 713 may request sensor data associated with the third sensor 711 and the fourth sensor 712 connected to the intermediate node apparatus 701, as well as sensor data associated with the first sensor 709 and the second sensor 710 connected to the neighboring node apparatus X 708. The data providing unit 706 may provide sensor data corresponding to the request message to the user terminal 713.

The neighboring node apparatus X 708 may also receive and store sensor data of the third sensor 711 and the fourth sensor 712 connected with the intermediate node apparatus 701. The sensors shown in FIG. 7 may include a carbon dioxide (CO₂) sensor, an image sensor, a temperature sensor, a humidity sensor, and the like, but the sensor are not limited thereto.

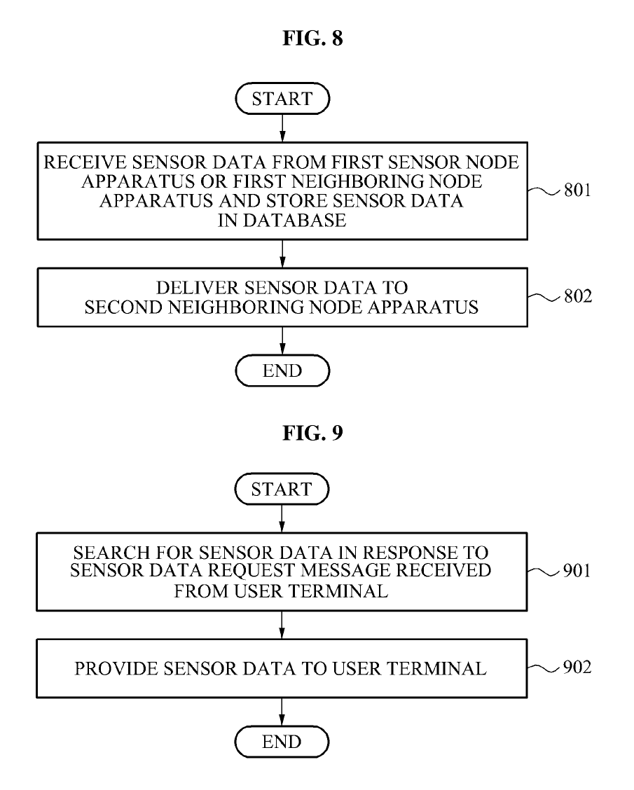

FIG. 8 is a flowchart illustrating a sensor data storing process of an intermediate node apparatus according to an embodiment of the present invention.

In operation 801, the intermediate node apparatus may receive sensor data from a first sensor node apparatus or a first neighboring node apparatus and may store the sensor data in a database. In this instance, the sensor node apparatus may store sensor data measured by a sensor. Also, the neighboring node apparatus may perform the same function as the intermediate node apparatus, and may receive sensor data from the sensor node apparatus and may deliver the sensor data to the intermediate node apparatus.

In operation 802, the intermediate node apparatus may deliver the sensor data to a second neighboring node apparatus. Here, a sensor network may include the first neighboring node apparatus, the intermediate node apparatus, and the second neighboring node apparatus. Also, the first neighboring node apparatus, the intermediate node apparatus, and the second neighboring node apparatus may route sensor data stored by the sensor node apparatus and may store the sensor data.

FIG. 9 is a flowchart illustrating a sensor data searching process of an intermediate node apparatus according to an embodiment of the present invention.

In operation 901, the intermediate node apparatus may receive a sensor data request message from a user terminal Also, the intermediate node apparatus may search for sensor data corresponding to the sensor data request message from a database.

For example, when the sensor data corresponding to the sensor data request message is absent in the database, the intermediate node apparatus may deliver the sensor data request message to a sensor data collecting server and may receive the sensor data corresponding to the sensor data request message from the sensor data collecting server.

Also, the intermediate node apparatus may search for a sensor node apparatus regionally associated with the intermediate node apparatus, and may join the sensor node apparatus. The intermediate node apparatus may join the sensor node apparatus through a neighboring node apparatus authorized to enable joining in the sensor node apparatus. Also, the intermediate node apparatus may join a sensor node apparatus associated with sensor data requested to be collected at least a predetermined number of times set by the user terminal.

In operation 902, the intermediate node apparatus may provide the sensor data to the user terminal.

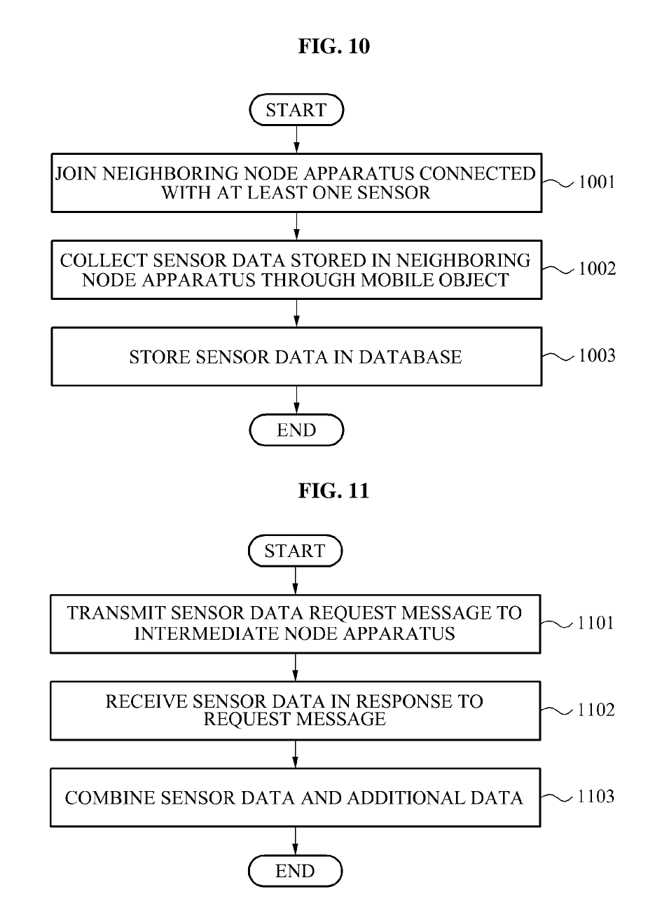

FIG. 10 is a flowchart illustrating a sensor data storing process of an intermediate node apparatus in a DTN according to an embodiment of the present invention.

In operation 1001, the intermediate node apparatus may join a neighboring node apparatus connected with at least one sensor. In this instance, the neighboring node apparatus and the intermediate node apparatus may perform the same operation as a sensor gateway.

In operation 1002, the intermediate node apparatus may collect sensor data stored in the neighboring node apparatus through a mobile object. That is, the intermediate node apparatus may not collect sensor data directly from the neighboring node apparatus and may collect the sensor data via the mobile object.

In operation 1003, the intermediate node apparatus may store the sensor data received from the neighboring node apparatus in a database.

FIG. 11 is a flowchart illustrating operation of a user terminal according to an embodiment of the present invention.

In operation 1101, the user terminal may transmit a sensor data request message to an intermediate node apparatus.

In operation 1102, the user terminal may receive sensor data in response to the request message.

In operation 1103, the user terminal may store the sensor data in a database.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

According to the exemplary embodiments, the intermediate node apparatus may store sensor data measured by a sensor node apparatus to allow a user terminal to collect sensor data without accessing a server.

According to the exemplary embodiments, the intermediate node apparatus may receive sensor data from a neighboring node apparatus or a sensor node apparatus, may store the sensor data, and may provide the sensor data to a user terminal.

According to the exemplary embodiments, the user terminal may collect sensor data without accessing a server by connecting to a neighboring intermediate node apparatus, and may combine the collected sensor data and map data.

According to the exemplary embodiments, the intermediate node apparatus may collect sensor data through a mobile object after joining another intermediate node apparatus.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An intermediate node apparatus for configuring a sensor network, the apparatus comprising:
a data storing unit to receive sensor data from a first sensor node apparatus or a first neighboring node apparatus and to store the sensor data in a database; and
a data delivery unit to deliver the sensor data stored in the database to a second neighboring node apparatus.

2. The apparatus of claim 1, further comprising:
a data searching unit to search the database for sensor data in response to a sensor data request message received from a user terminal; and
a data providing unit to provide the found sensor data to the user terminal.

3. The apparatus of claim 2, wherein the data searching unit delivers, when the sensor data corresponding to the sensor data request message is absent in the database, the sensor data request message to a sensor data collecting server, and receives the sensor data corresponding to the sensor data request message from the sensor data collecting server.

4. The apparatus of claim 2, wherein the user terminal combines the sensor data and map data.

5. The apparatus of claim 1, further comprising:
an apparatus joining unit to search for a second sensor node apparatus regionally associated with the intermediate node apparatus and to allow the intermediate node apparatus to join the second sensor node apparatus.

6. The apparatus of claim 5, wherein the apparatus joining unit allows the intermediate node apparatus to join the second sensor node apparatus through a third neighboring node apparatus authorized to enable joining in the second sensor node apparatus.

7. The apparatus of claim 1, further comprising:
an apparatus joining unit to allow the intermediate node apparatus to join a third sensor node apparatus associated with sensor data requested to be collected at least a predetermined number of times set by the user terminal connected with the intermediate node apparatus.

8. The apparatus of claim 7, wherein the third neighboring node apparatus automatically provides the sensor data to the intermediate node apparatus each time the third neighboring node apparatus measures the sensor data.

9. An intermediate node apparatus for configuring a sensor network, the apparatus comprising:
an apparatus joining unit to allow the intermediate node apparatus to join a neighboring node apparatus connected with at least one sensor; and
a data storing unit to collect sensor data stored in the neighboring node apparatus through a mobile object and to store the collected sensor data in a database.

10. The apparatus of claim 9, further comprising:
a data searching unit to search the database for sensor data in response to a sensor data request message received from a user terminal connected with the intermediate node apparatus; and
a data providing unit to provide the found sensor data to the user terminal.

11. The apparatus of claim 9, wherein the neighboring node apparatus collects the sensor data measured by the sensor connected with the intermediate node apparatus from the intermediate node apparatus, and stores the sensor data.

12. A user terminal connected with an intermediate node apparatus for configuring a sensor network, the user terminal comprising:
a message transmitting unit to transmit a sensor data request message to the intermediate node apparatus;
a data receiving unit to receive the sensor data in response to the request message being received; and
a data combining unit to combine the received sensor data and additional data.

13. The user terminal of claim 12, wherein the data combining unit combines the sensor data and map data and displays the combined data.

14. The user terminal of claim 12, wherein the intermediate node apparatus joins a neighboring node apparatus storing the sensor data corresponding to the request message, and
the data receiving unit receives the sensor data stored in the neighboring node apparatus.

15. The user terminal of claim 12, wherein the intermediate node apparatus collects sensor data by joining a sensor node apparatus associated with sensor data requested to be collected at least a predetermined number of times.

16. The user terminal of claim 12, wherein the intermediate node apparatus collects sensor data by joining a sensor node apparatus regionally associated with the intermediate node apparatus.

17. A sensor data processing method performed in an intermediate node apparatus for configuring a sensor network, the method comprising:
receiving sensor data from a first sensor node apparatus or a first neighboring node apparatus and storing the sensor data in a database; and
delivering the sensor data stored in the database to a second neighboring node apparatus.

18. The method of claim 17, further comprising:
searching the database for sensor data in response to a sensor data request message received from a user terminal; and
providing the found sensor data to the user terminal.

19. A sensor data processing method performed in an intermediate node apparatus for configuring a sensor network, the method comprising:
joining a neighboring node apparatus connected with at least one sensor;
collecting sensor data stored in the neighboring node apparatus through a mobile object; and
storing the collected sensor data in a database.

20. A sensor data processing method performed in a user terminal connected with an intermediate node apparatus for configuring a sensor network, the method comprising:
transmitting a sensor data request message to the intermediate node apparatus;
receiving sensor data in response to the request message; and
combining the received sensor data and additional data.
